(19) United States
(12) Patent Application Publication
(10) Pub. No.: US 2005/0094398 A1
(43) Pub. Date: May 5, 2005

(54) Portable illuminating device for fluid taps

(76) Inventor: Joseph Edward Currie, Webster, NH (US)

Correspondence Address: JOSEPH E. CURRIE, 506 WHITE PLAINS RD., WEBSTER, NH, 03303-7112, US

(21) Appl. No.: 10/967,884

(22) Filed: Oct. 18, 2004

Related U.S. Application Data
(60) Provisional application No. 60/514,976, filed on Oct. 29, 2003.

(51) Int. Cl. B67D 1/08; F21V 33/00

(52) U.S. Cl. 362/253

(57) ABSTRACT

Disclosed is an improved four part portable illumination system for a comestible fluid tap or dispenser comprised of a unique portable illumination device that is attached to the bottom side of a tap, immediately behind the liquid spout of the tap, and in position to direct colored light in the direction of the dispensed liquid flow, and an ultra-violet light sensitive comestible fluid container, and or container holder, and an ultra-violet light sensitive backsplash or curtain, and a ultra-violet sensitive drip tray. The colored illumination from a light emitting diode within the portable illumination device is input into a one-piece combination collimating lens and curved light conduit and directed toward a fluid receptacle. Electrical power for the solid-state illumination source is obtained from either a voltage source located within a carbonated fluid dispenser, or from a dedicated low voltage dc power supply.

### CROSS REFERENCE TO RRELATED APPLICATIONS

Please refer to Provisional Application Ser. No. 60/514,976, filing date Oct. 29, 2003.

### STATEMENT REGARDING FEDERALLY SPONSORED RESEARCH OR DEVELOPMENT

(Not Applicable)

### FIELD OF THE INVENTION

The present invention relates to portable illumination devices that attach to comestible fluid taps or dispensers.

### BACKGROUND OF INVENTION

This invention relates to comestible fluid taps and more particularly to comestible fluid taps with integrated illumination means. U.S. Pat. No. 5,491,617 issued to Joseph E. Currie on Aug. 4, 1996 discloses an illumination device designed primarily for attachment to a tap dispensing comestible fluids. The illumination device utilizes a separate illuminator that is comprised of a power supply and an illumination source or sources. A first and second light conduit of fiber optic cable is used to transmit light from the illuminator to the tap handle and to the tap spout. The light source in the illuminator is switched on and off by means of a provided electromechanical tilt switch, and the device incorporates a delay circuit that eliminates false switching of the halogen lamp light source or sources in the illuminator.

The above-cited patent does not describe the arrangement of features as disclosed in this new invention.

The present instant invention uses new technology and new ideas to create a new illumination device and system for use on a comestible fluid tap, or fluid dispenser, that creates a visual pleasing experience for a viewer of a dispensed liquid.

### SUMMARY OF THE INVENTION

The present invention describes an improved portable illumination device and system for attachment to a comestible fluid dispensing tap. The object of the present invention is to provide an attractive display of light to the dispensing of comestible fluids. The embodiment of the invention is comprised of a combination of four elements. The four elements of the combination are first a solid state illumination source such as a super bright solid-state colored light emitting diode or (LED), mounted in a portable unit with a one piece combination collimation lens and curved light conduit, affixed to, and in close proximity to, the comestible fluid dispensing spout. Second of the four elements is a colored plastic background or splashboard, preferably the color of the LED illumination, and preferably made of plastic that glows when exposed to ultraviolet or black light. The third element of the combination is a liquid container, and or container holder, made of any material or plastic, preferably the color of the LED light used with the particular dispenser, and that fluoresces under ultraviolet light, and the fourth item is a ultra-violet sensitive drip tray. These four elements in combination will illuminate the dispensing of a comestible fluid with a very bright and pleasing effect.

In the embodiment of the present invention the first element is comprised of a super bright solid-state light emitting diode emitting light through a one piece collimation lens and curved light conduit affixed behind the spout of a comestible fluid dispenser or tap, with a top cap designed to secure the illumination device to the underside of and behind the fluid spout. Certain comestible fluid dispensers are equipped with pressure switches against which the receptacle or drink cup is pushed to activate liquid flow. This switch connects direct current from an internal electrical power supply to activate a flow control valve causing pressurized liquid to fill a cup. The dc voltage connected to the flow control valve is also connected in the first embodiment of the present invention through a voltage-dropping resistor to power the LED in the present invention so that the LED illuminates only when liquid is flowing. Other comestible fluid taps require a handle to manually operate the fluid control valve to dispense liquids. The LED in the portable illumination device attached to this type of tap will be connected directly to a low voltage dc voltage source and illuminate continuously.

A second element of the present invention is a colored background, splashboard, or backdrop, behind the area where the comestible fluid is being dispensed, made of a colored plastic that fluoresces or glows when subjected to ultraviolet or black light. There are enough ultraviolet fight sources present in most establishments where soft comestible fluids are sold to partially illuminate the UVa sensitive plastic. Two such UVa light sources are direct and reflected sunlight and fluorescent lighting. The UVa sensitive plastic background will illuminate even more when the LED of the portable device illuminates, as LEDs are also a source of UVa light.

A third element of the present invention is to utilize a drink container or cup that will enhance the illuminating scheme. The cup may be made of colored material that matches the colored light from the present invention, or may be made of UVa sensitive colored plastic, or may be held by a cup holder made of colored material or colored UVa sensitive plastic.

A fourth element of the present invention is an UVa sensitive drip tray located under the tap spout.

### BRIEF DESCRIPTION OF THE DRAWINGS

FIG. 1 is a three dimensional exploded view of the portable illumination device.

FIG. 2 is a cut away view of the illumination device with attached electrical connectivity and a UV sensitive colored plastic backsplash, drip tray, and an UVa sensitive comestible fluid container.

### DETAILED DESCRIPTION OF THE EMBODIMENT OF THE INVENTION

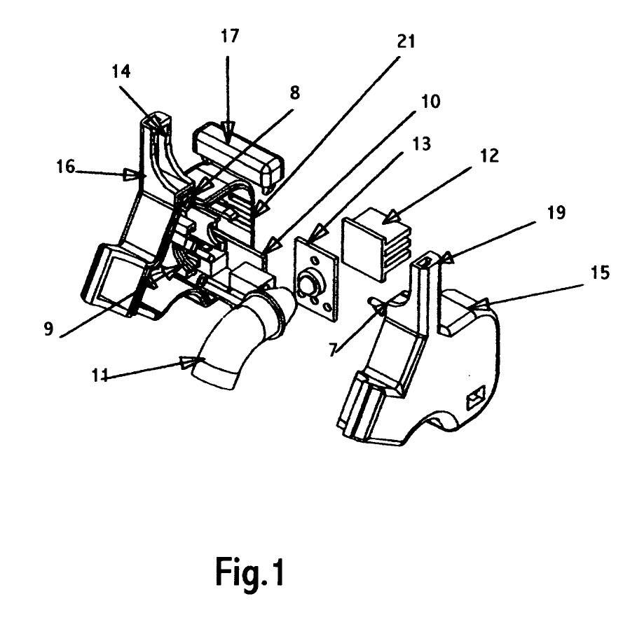

Referring now to the drawings, the present invention relates to a portable device providing for illumination beneath a fluid tap outlet that illuminates an ultra-violet light sensitive backsplash area, an ultraviolet sensitive fluid receptacle or receptacle holder, and an UVa sensitive drip tray. FIG. 1 discloses a three dimensional exploded view of the new portable illumination device. A first half of the outside shell 16 with the necessary internal structural supports 9 that hold board mounted light emitting diode LED 13, LED mounting base 10, metal heat sink 12, and one piece collimation lens and curved light conduit 11 in place is depicted here. Board mounted light emitting diode LED 13 is affixed to heat sink 12 and inserted into cavity 21 of device first half 16. Extended collimation lens and light conduit 11 is installed in cavity 21 of first half 16 in close proximity to LED 13. The second half 15 of the portable illumination device is installed onto the first half 16 by snap fit retention securing the bottom edge surface 8 of first half mounting collar 14 against the bottom edge surface 7 of the second half mounting collar 19 and holding LED 13, base 10, heat sink 12, and lens/conduit 11 securely in place. Illumination from LED 13 is directed downward through extended collimation lens and curved illumination conduit 11.

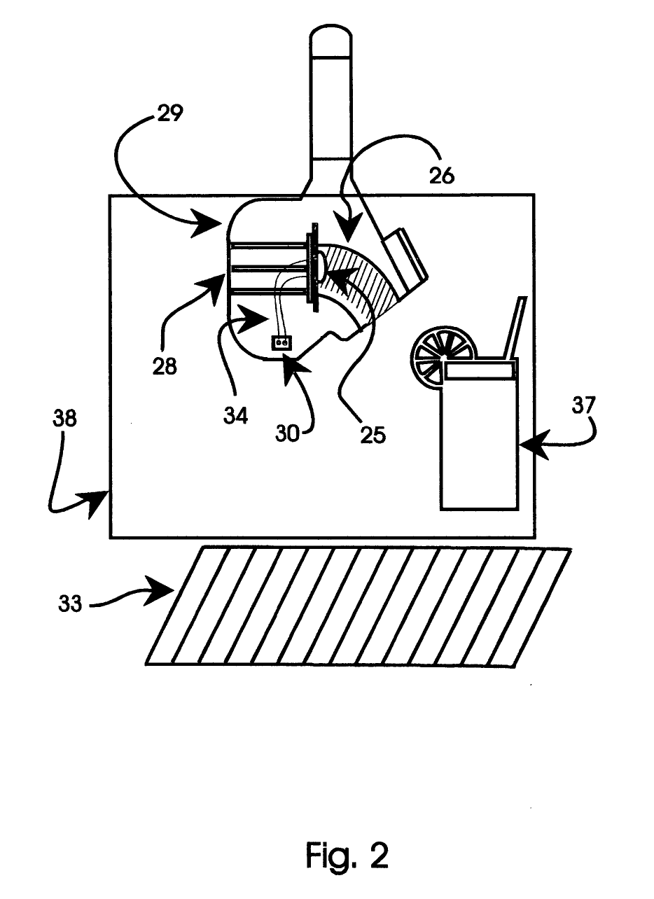

FIG. 2 shows a cut away view of portable illumination device 29 with light emitting diode 25 inserted into lens/collimator 26. Electrical conductors 34 are routed from LED 25 through heat sink 28 to female electrical connector 30. UVa sensitive backsplash area 38 is located below and behind portable illumination device 29 and a typical UVa sensitive comestible fluid container 37, with liquid collecting drip tray 33 completes the depiction.

1. A four-element comestible fluid tap illumination system consisting of;
first, a portable single light source illumination device,
second, a colored ultra-violet sensitive backsplash,
third, a ultraviolet sensitive liquid receptacle, and or receptacle holder,
and fourth, a ultra-violet sensitive drip tray;
the first element portable illumination device is affixed behind the spout of a comestible fluid tap or dispenser, and held securely in place by a collar designed to secure the illumination device to the underside of the tap; said portable illumination device is comprised of a two piece plastic injection molded outside cover, with internal supports for a one piece combination light collimating lens and curved light director, a board mounted light emitting diode (LED) mounted on a detachable base, and a metal heat sink required to remove heat from the LED;
and with the two outside cover pieces of the illumination device designed to snap fit together with locking pins and groves so as to securely contain the one-piece lens and light conduit, board mounted LED on a mounting base, and metal heat sink;
and a dual function bridging cap with a first flat side and a second concave side of the bridging cap designed to mount on a tap, with either the first flat side or the second concave side facing down onto a flat or convex tap surface as appropriate, and connecting together the top of the two sides of the portable light device, and securing the portable light device against the bottom surface of the tap proximate and behind the liquid dispensing spout;
and miniature two pin female electrical connecting plugs installed into both of the injection molded sides of the illumination device, with the pins of each plug electrically connected to the internal LED of this instant invention, allowing the illumination device of this instant invention to be connected electrically in series with other same illumination devices;
and using the electrical power supply of a soft drink liquid dispenser that is switched on when a glass or cup is pushed against a liquid flow control switch as the electrical energy power source for the internal LED of the illumination device, or using a dedicated power supply directly connected to the LED of the illumination device;
the second element of the illumination system is a colored ultra-violet sensitive backsplash or backboard located behind the tap spout;
the third element of the illumination system is a ultra-violet sensitive liquid receptacle or container, and or container holder,
and the fourth element of said illumination system is a ultra-violet sensitive drip tray for collection of spilled liquid located under the tap spout.
